(19) United States
(12) Patent Application Publication
(10) Pub. No.: US 2025/0353269 A1
(43) Pub. Date: Nov. 20, 2025

(54) COFFEE CAPSULE MACHINE WITH ARCUATE POWDER COMPACTING DEVICE

(71) Applicant: ZHEJIANG TIANXIKITCHEN APPLIANCE CO.,LTD., LISHUI (CN)

(72) Inventors: JUN YUAN, LISHUI (CN); YUQING LIANG, LISHUI (CN); TINGBIN TANG, LISHUI (CN); DEQUAN CAI, LISHUI (CN); KAIHONG MA, LISHUI (CN); XIYAN CHEN, LISHUI (CN); TING LYU, LISHUI (CN)

(21) Appl. No.: 19/281,795

(22) Filed: Jul. 28, 2025

(30) Foreign Application Priority Data
Dec. 20, 2024 (CN) 202411891007.7

(51) Int. Cl. B30B 15/30; A47J 42/40; B02C 11/00

(52) U.S. Cl. CPC B30B 15/30; A47J 42/40; B02C 11/00

(57) ABSTRACT

The present invention provides a coffee capsule machine, comprises a housing, a grinding unit disposed on the housing and including a grinding container, and an arcuate powder compacting unit. The arcuate powder compacting unit comprises an arcuate powder compacting channel extending upward from bottom to top, a tamping hammer slidably disposed within the arcuate powder compacting channel, and a driving mechanism configured to drive the tamping hammer to slide along the arcuate powder compacting channel. The arcuate powder compacting channel comprises, from top to bottom, a driving end, a transition section, and a powder outlet end. The powder outlet end is located below the grinding container, and the transition section is arranged to bypass the grinding container. This configuration results in a more compact internal layout within the housing, thereby reducing the overall size of the coffee capsule machine and lowering packaging and transportation costs.

### TECHNICAL FIELD

The present invention relates to the technical field of coffee capsule machines, and more particularly to a coffee capsule machine equipped with arcuate powder-compacting device

### BACKGROUND

At present, certain coffee capsule machines available on the market are capable of grinding coffee beans into coffee powder and subsequently preparing coffee capsules. These machines generally comprise a grinding unit and a powder-compacting unit. The grinding unit grinds the coffee beans into powder, which is then delivered via a powder outlet channel into a compacting channel of the compacting unit. The powder subsequently flows into a capsule holder located at the lower end of the compacting channel, where it is compacted by a tamping hammer moving downward along the channel. In existing designs, the grinding unit and the compacting unit are arranged side by side within the machine housing. The grinding container typically has a conical shape that narrows from top to bottom, and the compacting channel is oriented vertically. To prevent the conical container from interfering with the vertical movement of the tamping hammer, a significant horizontal spacing is required between the compacting channel and the grinding container. This increases the overall size of the coffee capsule machine, resulting in higher packaging and transportation costs.

### SUMMARY

The present invention provides a coffee capsule machine equipped with an arcuate powder-compacting device, aiming to address the problem in the prior art whereby the vertically oriented compacting channel requires a large horizontal spacing from the grinding container, thereby resulting in an overall bulky structure for the coffee capsule machine.

In order to address the above-mentioned technical problems, the technical solution adopted by the present invention is as follows.

The present invention provides a coffee capsule machine comprising an arcuate powder compacting device, the machine comprising:
a housing;
a grinding unit disposed on the housing, the grinding unit comprises a grinding container; and
an arcuate powder compacting unit disposed within the housing and arranged in parallel with the grinding unit, the arcuate powder compacting unit comprises an arcuately arranged powder compacting channel extending from bottom to top, a tamping hammer slidably disposed within the arcuate powder compacting channel, and a driving mechanism configured to drive the tamping hammer to slide along the arcuate powder compacting channel,
wherein the arcuate powder compacting channel comprises, in order from top to bottom, a driving end, a transition section, and a powder outlet end, the powder outlet end being located below the grinding container, and the transition section bypassing the grinding container, with the powder outlet end being provided with a powder discharge port.

As a further embodiment, the arcuate powder compacting channel gradually arches upward gradually from the lower front side of the grinding container, extending in an arcuate path either from left to right or from right to left.

Based on the above technical solution, such a configuration facilitates the downward sliding motion of the tamping hammer driven by the driving mechanism, thereby compacting the coffee powder inside the capsule holder located below the powder discharge port.

As a further embodiment, the grinding container comprises a cylindrical upper container and a conical lower container that tapers gradually from top to bottom. The powder outlet end is located at the lower front side of the conical container. The transition section of the arcuate compacting channel extends upward from below and bypasses the lower front surface of the conical container, either from right to left or from left to right.

Based on the above technical solution, this arrangement not only increases the capacity of the grinding container but also facilitates the installation of a grinding assembly inside or below the grinding container. Moreover, the conical container does not interfere with the up-and-down motion of the tamping hammer, thereby reducing the spacing between the arcuate powder compacting channel and the grinding container, resulting in a more compact internal layout.

As a further embodiment, the driving mechanism comprises a tamping motor and a transmission assembly. The transmission assembly includes a gear set and an arcuate rack.

The output shaft of the tamping motor is connected to the input end of the gear set, and the output end of the gear set is connected to the arcuate rack. The arcuate rack is slidably disposed within the arcuate powder compacting channel, with its lower end connected to the tamping hammer.

Based on the above technical solution, the driving motor drives the tamping hammer to slide up and down along the arcuate powder compacting channel via the gear set and arcuate rack, thereby enabling a more compact and reasonable overall layout.

In a further embodiment, the gear set comprises a first gear and a second gear. An output shaft of the tamping motor is connected to the first gear, and the second gear is engaged with both the first gear and the arcuate rack.

In a further embodiment, the engagement teeth of the arcuate rack are located on an inner side thereof.

Based on the above technical solution, the above configuration facilitates efficient use of the space enclosed by the arcuate powder compacting channel for placing the driving mechanism, thereby resulting in a more compact layout.

In a further embodiment, a mounting seat is provided on a side wall of the arcuate powder compacting channel, and the driving mechanism is disposed on the mounting seat.

In a further embodiment, a clearance slot is formed on the side wall of the arcuate powder compacting channel, and the second gear extends through the clearance slot to engage with the arcuate rack.

In a further embodiment, the arcuate rack and the tamping hammer are integrally formed or fixedly connected.

Based on the above technical solution, the configuration is preferably integrally formed, which facilitates machining and assembly.

In a further embodiment, a sealing ring is provided between the tamping hammer and the inner wall of the arcuate powder compacting channel.

Based on the above technical solution, the sealing ring serves a sealing function to prevent coffee powder from entering the housing from the arcuate powder compacting channel.

In a further embodiment, the grinding unit further comprises a grinding assembly disposed inside the grinding container. A powder guiding channel is provided between the grinding assembly and the arcuate powder compacting channel. The coffee powder ground by the grinding assembly flows through the powder guiding channel into the arcuate powder compacting channel.

Based on the above technical solution, the configuration allows the coffee powder ground by the grinding assembly to flow directly into the arcuate powder compacting channel via the powder guiding channel, and then fall into a capsule holder at the lower end of the arcuate powder compacting channel. Thereafter, the driving mechanism can be directly activated to drive the tamping hammer to compact the coffee powder in the capsule holder, thereby ensuring a smoother and more continuous process.

The present invention provides the following beneficial effects:

By configuring the powder compacting channel to extend upward in an arcuate shape, and by positioning the powder outlet end of the arcuate powder compacting channel below the grinding container with the transition section arranged to bypass the grinding container, the arcuate powder compacting channel and the grinding container can be arranged more compactly within the housing. This reduces the space occupied and thereby decreases the overall size of the coffee capsule machine, resulting in lower packaging and transportation costs. In addition, the arcuate configuration of the powder compacting channel not only avoids interference between the tamping hammer and the grinding container during the vertical sliding process, but also ensures that the tamping stroke of the tamping hammer meets the required compacting effectiveness.

### BRIEF DESCRIPTION OF THE DRAWINGS

In order to more clearly illustrate the technical solutions of the embodiments of the present invention, the drawings required for describing the embodiments are briefly introduced below. It should be understood that the following drawings merely depict certain embodiments of the present invention and therefore should not be regarded as limitations of the scope of the invention. For those skilled in the art, other related drawings may also be obtained based on these drawings without making any creative efforts.

FIG. 1 is a sectional structural schematic view of the coffee capsule machine according to the present invention.

FIG. 2 is a structural schematic view of the grinding container and the arcuate powder compacting unit.

FIG. 3 is a structural schematic view showing the driving mechanism mounted on the mounting seat.

FIG. 4 is a sectional structural schematic view of the arcuate powder compacting channel.

The reference numbers in the drawings are as follows:
housing 1; grinding unit 11; grinding assembly 12; arcuate powder compacting unit 13; driving mechanism 14; transmission assembly 15; gear set 16; grinding container 2; powder guiding channel 21; arcuate powder compacting channel 3; clearance slot 31; powder discharge port 32; mounting seat 33; first gear 331; second gear 332; arcuate guide groove 34; driving end 35; transition section 36; powder outlet end 37; tamping hammer 4; arcuate rack 41; guide block 411; tamping motor 5; sealing ring 6.

### DETAILED DESCRIPTION OF EMBODIMENTS

The technical solutions in the embodiments of the present invention will be illustrated in detail in combination with the accompanying drawings. It should be understood that the specific embodiments described herein are merely intended to explain the present invention and are not intended to limit the present invention. Based on the embodiments of the present invention, all other embodiments obtained by those skilled in the art without making creative efforts shall fall within the scope of protection of the present invention.

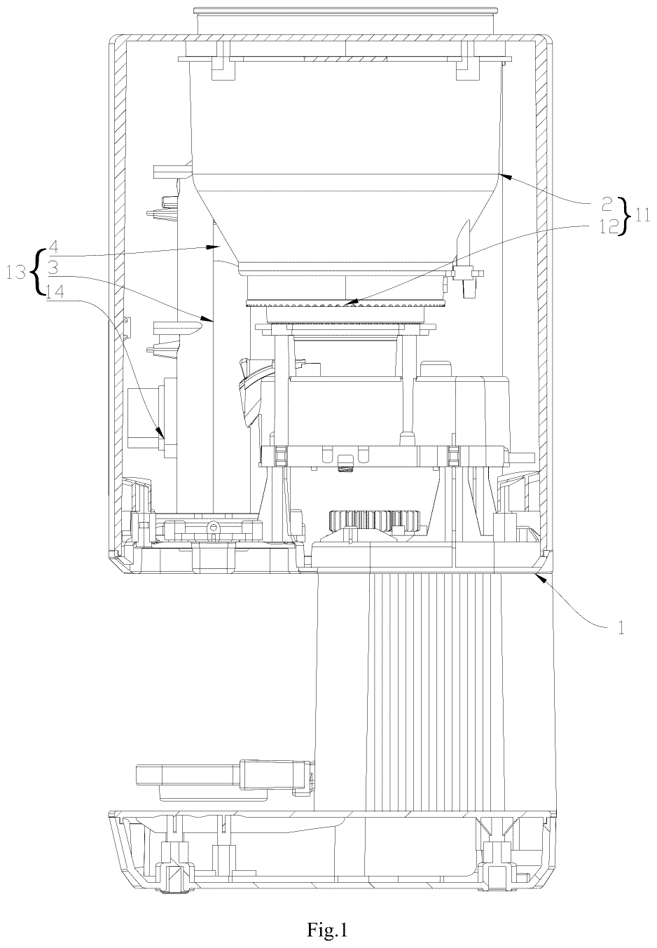

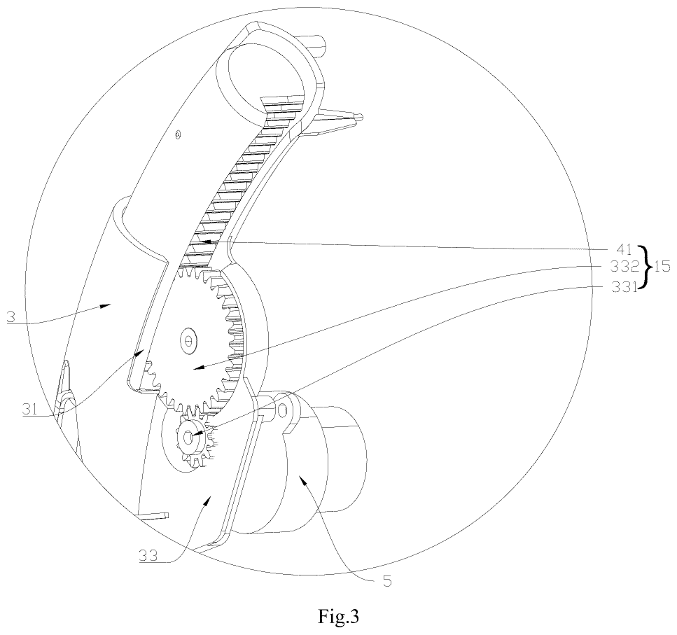

As shown in FIGS. 1 to 4, the present embodiment provides a coffee capsule machine equipped with an arcuate powder compacting device, comprising:
a housing 1;
a grinding unit 11 disposed on the housing 1, the grinding unit 11 comprising a grinding container 2, the grinding container 2 being configured for receiving coffee beans, and a grinding assembly 12 being mounted at the bottom of the grinding container 2 for grinding the coffee beans into coffee powder; and
an arcuate powder compacting unit 13 disposed inside the housing 1 and arranged in parallel with the grinding unit 11, the arcuate powder compacting unit 13 comprising an arcuate powder compacting channel 3 extending upward in an arcuate shape, a tamping hammer 4 slidably disposed in the arcuate powder compacting channel 3 for vertical movement, and a driving mechanism 14 configured to drive the tamping hammer 4 to move up and down along the arcuate powder compacting channel 3.

Specifically, when performing a compacting operation, the driving mechanism 14 drives the tamping hammer 4 to slide downward from an upper reset position to a lower compacting position along the arcuate powder compacting channel 3; after the compacting is completed, the driving mechanism 14 drives the tamping hammer 4 to return upward from the compacting position to the reset position along the arcuate powder compacting channel 3.

The arcuate powder compacting channel 3 is fixedly mounted on a mounting seat inside the housing 1, and the arcuate powder compacting channel 3 comprises, in order from top to bottom, a driving end 35, a transition section 36, and a powder outlet end 37. The powder outlet end 37 is located below the grinding container 2, and the transition section 36 is arranged to bypass the grinding container 2 such that the driving end 35 is not interfered with by the shape of the grinding container 2.

Specifically, when the driving mechanism 14 drives the tamping hammer 4 to move up and down along the arcuate powder compacting channel 3, the grinding container 2 does not interfere with the movement path of the tamping hammer 4. The powder outlet end 37 is provided with a powder discharge port 32, which is used to interface with a capsule holder.

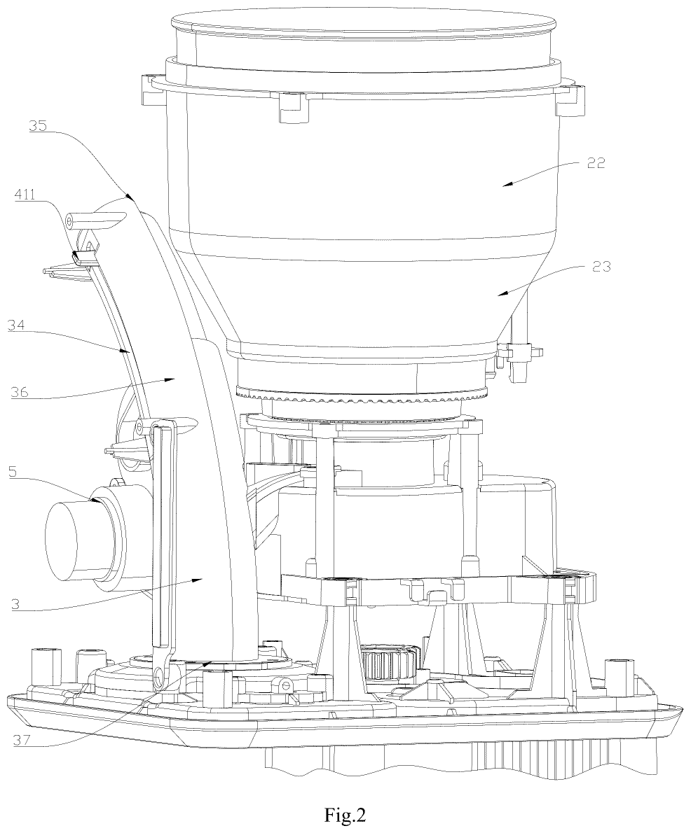

In some specific embodiments, as shown in FIGS. 1 and 2, the arcuate powder compacting channel 3 gradually arches upward from below the front side of the grinding container 2, either from left to right or from right to left. The grinding container 2 comprises an upper cylindrical container and a lower conical container with a gradually decreasing diameter from top to bottom. Preferably, the cylindrical container and the conical container are integrally formed. To facilitate powder reception by the capsule holder, the powder outlet end 37 is located at the lower front side of the conical container, and the transition section 36 extends from the lower part of the front surface of the conical container upward and bypasses the container from right to left.

Specifically, the powder outlet end 37 is disposed at the lower front portion of the conical container, such that the horizontal distance between the two is reduced, enabling a more compact structural layout inside the housing 1 and further reducing the overall size of the coffee capsule machine. When the transition section 36 bypasses the conical container, the grinding container 2 does not interfere with the movement of the tamping hammer 4, and the tamping stroke is correspondingly increased, thereby meeting the compacting requirements.

In an alternative configuration of the above embodiment, the powder outlet end 37 is located at the lower front side of the conical container, and the transition section 36 extends from the front surface of the conical container upward and bypasses the container from left to right.

In some specific embodiments, as shown in FIGS. 2 to 4, a mounting seat 33 is provided on the side wall of the arcuate powder compacting channel 3, and the driving mechanism 14 is disposed on the mounting seat 33. In one specific structure, the driving mechanism 14 comprises a tamping motor 5 and a transmission assembly 15. The transmission assembly 15 includes a gear set 16 and an arcuate rack 41. The output shaft of the tamping motor 5 is connected to the input end of the gear set 16, and the output end of the gear set 16 is connected to the arcuate rack 41 by gear engagement. The arcuate rack 41 is slidably disposed within the arcuate powder compacting channel 3, and the lower end of the arcuate rack 41 is connected to the tamping hammer 4. The arcuate rack 41 and the tamping hammer 4 may be configured as integrally formed or fixedly connected.

When the tamping motor 5 drives the gear set 16 to rotate, the gear set 16 engages with the arcuate rack 41 to drive the arcuate rack 41 and the tamping hammer 4 to move up and down, thereby performing a tamping operation or returning to the reset position.

As shown in FIG. 1 to FIG. 4, there are two front wheels 13 located on the left and right underneath a front side of the car body 1, and there are two rear wheels 14 located on left and right underneath a rear side of the car body 1. The car body 1 is provided with a steering wheel 11 and a riding portion 12 for children to ride and operate the car body 1. The steering wheel 11 can be configured to be detachably connected to the car body 1, so that the steering wheel 11 can be detached during packaging and transportation to facilitate easier packaging. Specifically, the steering wheel 11 is detachably connected to the car body 1 by means of a plug-in structure.

The gear set 16 comprises a first gear 331 and a second gear 332. The output shaft of the tamping motor 5 is connected to the first gear 331, and the second gear 332 is engaged with both the first gear 331 and the arcuate rack 41.

In some specific embodiments, as shown in FIGS. 2 to 4, in order to achieve a more compact internal layout within the housing 1, the engagement teeth of the arcuate rack 41 are located on its inner side. As such, the mounting seat 33 and the driving mechanism 14 can be disposed within the inner space enclosed by the arcuate powder compacting channel 3. To facilitate the engagement transmission between the second gear 332 and the arcuate rack 41, a clearance slot 31 is provided on the side wall of the arcuate powder compacting channel 3. The second gear 332 extends through the clearance slot 31 to engage with the arcuate rack 41.

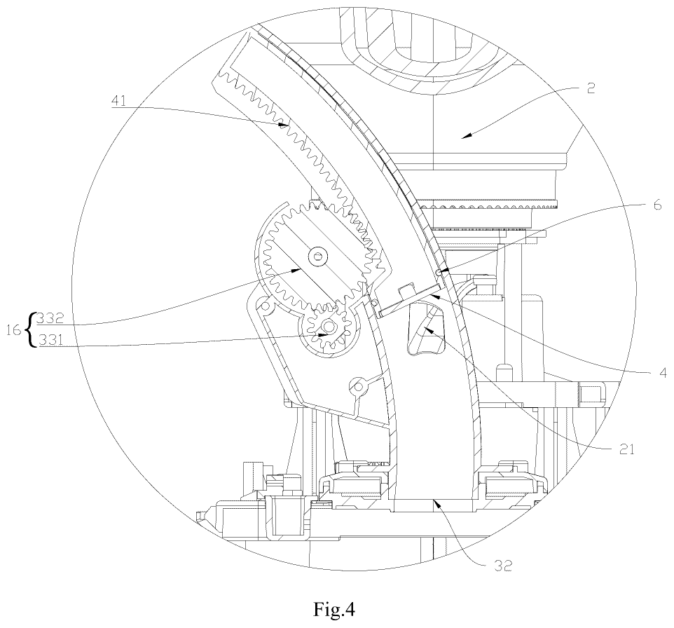

In some specific embodiments, as shown in FIG. 4, a sealing ring 6 is provided between the tamping hammer 4 and the inner wall of the arcuate powder compacting channel 3. The sealing ring 6 serves a sealing function to prevent coffee powder from entering the housing 1 from the arcuate powder compacting channel 3. An arcuate guide groove 34 is further provided on the side wall of the arcuate powder compacting channel 3. A guide block 411 is provided on the arcuate rack 41, and the guide block 411 is positioned within the arcuate guide groove 34, thereby limiting the upper and lower positions of the arcuate rack 41.

In some specific embodiments, the grinding unit 11 further comprises a grinding assembly 12 disposed inside the grinding container 2. The grinding assembly 12 specifically includes a grinding blade and a grinding motor configured to drive the grinding blade to grind the coffee beans. A powder guiding channel 21 is provided between the grinding assembly and the arcuate powder compacting channel 3. The coffee powder ground by the grinding assembly flows into the arcuate powder compacting channel 3 through the powder guiding channel 21, then falls into a capsule holder at the lower end of the arcuate powder compacting channel 3. Thereafter, the driving mechanism 14 can be directly activated to drive the tamping hammer 4 to perform the tamping operation on the coffee powder inside the capsule holder, thereby improving the process continuity.

The working principle is described as follow.

The arcuate powder compacting channel 3 is curved upward in an arcuate path from the lower side of the conical container and bypasses the conical container toward the left, thereby avoiding a vertically upward path that would directly interfere with the conical container. This arrangement further reduces the horizontal spacing between the arcuate powder compacting channel 3 and the conical container, which in turn reduces the overall size of the coffee capsule machine. During the tamping operation, the tamping motor 5 drives the arcuate rack 41 to slide downward via the gear set 16, thereby causing the tamping hammer 4 to slide downward along the arcuate powder compacting channel 3 to perform the tamping process.

The present invention is not limited to the above optional embodiments. Provided that there is no conflict among the various solutions, the features described herein may be freely combined. Any other forms of products derived under the inspiration of the present invention shall fall within the scope of protection of the present invention, regardless of any changes made to their shapes or structures, so long as the technical solutions fall within the scope defined by the claims.

What is claimed is:

1. A coffee capsule machine with arcuate powder compacting device, comprising:
a housing;
a grinding unit disposed on the housing, the grinding unit comprises a grinding container; and
an arcuate powder compacting unit disposed inside the housing and arranged in parallel with the grinding unit, the arcuate powder compacting unit comprises an arcuate powder compacting channel extending upward in an arcuate shape, a tamping hammer slidably disposed in the arcuate powder compacting channel, and a driving mechanism configured to drive the tamping hammer to slide along the arcuate powder compacting channel,
wherein the arcuate powder compacting channel comprises, from top to bottom, a driving end, a transition section, and a powder outlet end; the powder outlet end is located below the grinding container; the transition section bypasses the grinding container; and the powder outlet end is provided with a powder discharge port.

2. The coffee capsule machine according to claim 1, wherein the arcuate powder compacting channel arches upward gradually from a lower front side of the grinding container, extending in an arcuate path either from left to right or from right to left.

3. The coffee capsule machine according to claim 2, wherein the grinding container comprises an upper cylindrical container and a lower conical container with a gradually decreasing diameter from top to bottom;
the powder outlet end is located at a lower front side of the conical container, the transition section bypasses the lower front side of the conical container upwardly from right to left.

4. The coffee capsule machine according to claim 2, wherein the grinding container comprises an upper cylindrical container and a lower conical container with a gradually decreasing diameter from top to bottom;
the powder outlet end is located at a lower front side of the conical container, the transition section bypasses the lower front side of the conical container upwardly from left to right.

5. The coffee capsule machine according to claim 2, wherein the driving mechanism comprises a tamping motor and a transmission assembly;
the transmission assembly comprises a gear set and an arcuate rack, an output shaft of the tamping motor is connected to an input end of the gear set, an output end of the gear set is connected to the arcuate rack, the arcuate rack is slidably disposed in the arcuate powder compacting channel, and a lower end of the arcuate rack is connected to the tamping hammer.

6. The coffee capsule machine according to claim 5, wherein the gear set comprises a first gear and a second gear;
the output shaft of the tamping motor is connected to the first gear, and the second gear is engaged with both the first gear and the arcuate rack.

7. The coffee capsule machine according to claim 6, wherein a clearance slot is provided on a side wall of the arcuate powder compacting channel, the second gear passes through the clearance slot to engage with the arcuate rack.

8. The coffee capsule machine according to claim 5, wherein engagement teeth of the arcuate rack are located on an inner side thereof.

9. The coffee capsule machine according to claim 5, wherein a mounting seat is provided on a side wall of the arcuate powder compacting channel, the driving mechanism is mounted on the mounting seat.

10. The coffee capsule machine according to claim 5, wherein the arcuate rack and the tamping hammer are integrally formed or fixedly connected.

11. The coffee capsule machine according to claim 5, wherein an arcuate guide groove is further provided on a side wall of the arcuate powder compacting channel, a guide block is provided on the arcuate rack, the guide block is positioned in the arcuate guide groove for limiting upper and lower positions of the arcuate rack.

12. The coffee capsule machine according to claim 1, wherein a sealing ring is provided between the tamping hammer and an inner wall of the arcuate powder compacting channel.

13. The coffee capsule machine according to claim 1, wherein the grinding unit further comprises a grinding assembly disposed in the grinding container, a powder guiding channel is provided between the grinding assembly and the arcuate powder compacting channel, such that coffee powder ground by the grinding assembly flows into the arcuate powder compacting channel through the powder guiding channel.
